(19) United States
(12) Patent Application Publication
(10) Pub. No.: US 2010/0332967 A1
(43) Pub. Date: Dec. 30, 2010

(54) SYSTEM AND METHOD FOR AUTOMATICALLY GENERATING WEB PAGE AUGMENTATION

(75) Inventors: Reiner Kraft, Gilroy, CA (US); Michael Chow, San Mateo, CA (US); Ethan Yi Zhang, San Jose, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/492,034

(22) Filed: Jun. 25, 2009

(51) Int. Cl. G06F 17/30; G06F 17/00

(52) U.S. Cl. 715/234; 707/769; 707/759; 707/713

(57) ABSTRACT

Embodiments of the present application provide methods and systems for automatically generating web page augmentation for web pages. In one embodiment, a computer implemented method for automatically providing a web page augmentation is provided. The method includes analyzing content of a web page to determine if a web page augmentation is needed for the web page. If the web page augmentation is needed, the method proceeds to determine a type of web page augmentation needed for the web page based on the content of the web page. The method also includes issuing a request to generate the web page augmentation, and receiving the web page augmentation sent by a web page augmentation generating system. The method further includes displaying the web page augmentation.

### CROSS REFERENCE TO RELATED APPLICATIONS

This application is related to U.S. patent application Ser. No. 12/238,234, entitled to “Building a Topic Based Webpage Based on Algorithmic And Community Interaction,” and filed on Sep. 25, 2008, and U.S. patent application Ser. No. 12/116,195, entitled “Algorithmically Generated Topic Pages,” and filed on May 6, 2008. Both applications are incorporated herein by reference in their entireties for all purposes.

### BACKGROUND OF THE INVENTION

The Internet is a global system of interconnected computer networks. The vast amount of information distributed across the Internet allows people around the world to access information posted on different web sites instantly. It has also lead to the development of the Internet as an effective tool for information search. When users review web pages, they often seek additional information regarding the content on the page. When users conduct informational searches or online shopping, they often need to conduct searches on multiple sites. For example, when issuing an exploratory query on a search engine, a user often conducts the same search on multiple search engines and/or content sites, such as Yahoo! News™, Yahoo! Answers™, YouTube™, Flickr™, and CNN™. The current solution is to open each search or content site to conduct searches. If the user does not know which site has the information he/she wants, it can take several trials to reach the desired information. Sometimes the search results can still be poor after numerous trials, if the user does not know which site would provide the most relevant information. Another example is when a user wants to compare price for a product on a number of online shopping sites to find a good deal on the product. Currently, the user needs to conduct price searches on multiple shopping sites to compare prices. Such price comparison is very time consuming for users.

In addition, when a user is reading a news story, the user often needs quick contextual help regarding terms, such as persons' names, places, organizations, and technical terms, etc., mentioned in the story. The current solution to this situation would require the user to take multiple steps to find the meaning or background of the term. The multiple steps might include: opening a search window, copying and pasting the term into a search box, reviewing search results, clicking on relevant search result links, and viewing information displayed in the clicked links. Finding desired information for these terms can be very time consuming.

It is in this context that embodiments of the invention arise.

### SUMMARY OF THE INVENTION

Embodiments of the present application provide methods and systems for automatically generating web page augmentation for web pages. In one embodiment, a computer implemented method for automatically providing a web page augmentation is provided. The method includes analyzing content of a web page to determine if a web page augmentation is needed for the web page. If the web page augmentation is needed, the method proceeds to determine a type of web page augmentation needed for the web page based on the content of the web page. The method also includes issuing a request to generate the web page augmentation, and receiving the web page augmentation sent by a web page augmentation generating system. The method further includes displaying the web page augmentation.

It should be appreciated that the present invention can be implemented in numerous ways, including as a method, a system, or a device. Several inventive embodiments of the present invention are described below.

In one embodiment, a computer implemented method for automatically providing a web page augmentation is provided. The computer implemented method includes receiving a search request with a search keyword, and generating a search result page having search results. The search results are generated based on the search keyword. The computer implemented method also includes displaying the search result page, and receiving a request for an augmented information page for the search result page. The request includes the search keyword. The computer implemented method further includes retrieving the augmented information page, and displaying the augmented information page that is retrieved.

In another embodiment, a computer implemented method for automatically providing a web page augmentation is provided. The computer implemented method includes receiving a request to generate term links for terms of augmentation value in a web page, and parsing words in the web page. The computer implemented method also includes mapping the words in the web page to a database of terms of augmentation value to identify terms to create the term links, and generating code for highlighting the identified terms. The computer implemented method further includes integrating the generated code into an original code of the web page, and generating a new web page with the identified terms highlighted. In addition, the computer implemented method includes receiving a request to generate an augmentation page for a highlighted term in the new web page, generating the requested augmentation page, and displaying the requested augmentation page.

In another embodiment, a computer implemented method for automatically providing a web page augmentation is provided. The computer implemented method includes analyzing content of a web page to determine if a web page augmentation is needed for the web page. If the web page augmentation is needed, the computer implemented method includes determining a type of web page augmentation needed for the web page based on the content of the web page. The computer implemented method also includes issuing a request to generate the web page augmentation, and receiving the web page augmentation sent by a web page augmentation generating system. The computer implemented method further includes displaying the web page augmentation. If the web page augmentation is not needed, do nothing.

In yet another embodiment, a system for automatically generating a web page augmentation is provided. The system includes a central system having a search engine for generating search results for search queries, and a glue page and topic page generator. A glue page is an augmented information page of a search query and a topic page is an augmented web page with search results for the search query and augmented information related to the search query. The central system also includes a shortcut generator, wherein the shortcut generator creates shortcuts for web pages. The system further includes a computer with a browser extension. A user can activate the browser extension. The browser extension issues requests for web page augmentation to the central system.

### BRIEF DESCRIPTION OF THE DRAWINGS

The present invention will be readily understood by the following detailed description in conjunction with the accompanying drawings, and like reference numerals designate like structural elements.

FIG. 1A shows a computer screen with a search result page, in accordance with one embodiment of the present invention.

FIG. 1B shows an informational page, in accordance with one embodiment of the present invention.

FIG. 1C shows a topic page, in accordance with one embodiment of the present invention.

FIG. 1D shows a selection area, in accordance with one embodiment of the present invention.

FIG. 2A illustrates a high-level block diagram of various functional elements of a computer system used in generating a glue page for a subject, in accordance with one embodiment of the present invention.

FIG. 2B illustrates a high-level block diagram of various functional elements of a computer system used in generating a topic page for a search query on a search web page, in accordance with one embodiment of the present invention.

FIG. 2C illustrates a simplified block diagram of another embodiment of a topic page, in accordance with one embodiment of the present invention.

FIG. 3A shows a web page of a news story with terms of augmentation value highlighted, in accordance with one embodiment of the present application.

FIG. 3B shows a database of terms of augmentation value, in accordance with one embodiment of the present invention.

FIG. 4 shows a system for automatically generating web page augmentation, in accordance with one embodiment of the present invention.

FIG. 5A shows a process flow for automatically generating a web page augmentation, in accordance with one embodiment of the present invention.

FIG. 5B shows a process flow for automatically generating a web page augmentation, in accordance with another embodiment of the present invention.

FIG. 5C shows a process flow for automatically generating a web page augmentation, in accordance with another embodiment of the present invention.

FIG. 5D shows a process flow for automatically generating a web page augmentation, in accordance with yet another embodiment of the present invention.

### DETAILED DESCRIPTION

As mentioned above, when users conduct information searches on the Internet, users may not know where the information resides. Often, users would begin information searching using a search engine. In one embodiment, a computer implemented method and system are provided, which enable users to select when to activate an interface to automatically retrieve additional information for content being viewed on particular pages. The interface, in one embodiment, is a piece of code that works as part or with a browser, to augment information currently being displayed. The interface may be downloaded to a browser to work as a toolbar or can work as a widget (e.g., small application).

In specific embodiments, users are able to browse to any webpage, from any publisher, over the internet, and once at a particular page of interest, the interface can augment the webpage with additional content related to the particular search terms or can directly augment the webpage. Augmenting the web page can occur when searching is conducted, and the key words used for searching are used to generate additional content, referred to as “glue” pages. If the webpage is augmented directly, the webpage may be modified, such that particular key terms (e.g., text, icons, images, etc.) in the webpage are provided with extended data. In this example, the extended data may be to transform simple text into links. The links will therefore provide further information, directly from the currently viewed page. In particular embodiments, a feature is provided to enable users to directly select when to augment a page, no matter who the publisher of the page is, and who created the page. Thus, without requiring the native code or special programming by the web page publisher, users can augment pages by selecting to activate an interface. In light of this overview, the following will illustrate some examples associated with embodiments of the present invention.

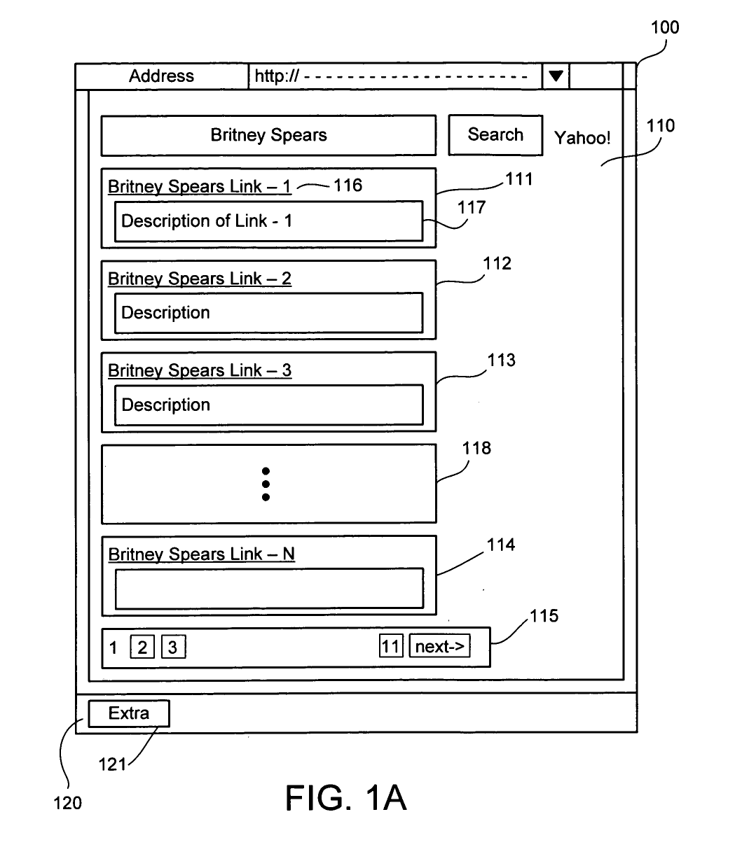

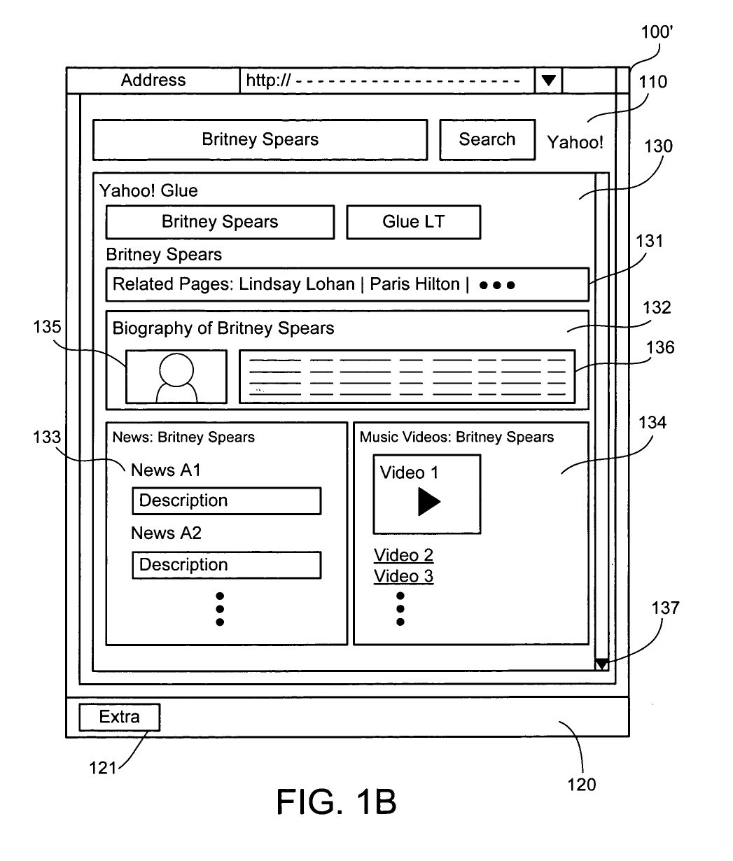

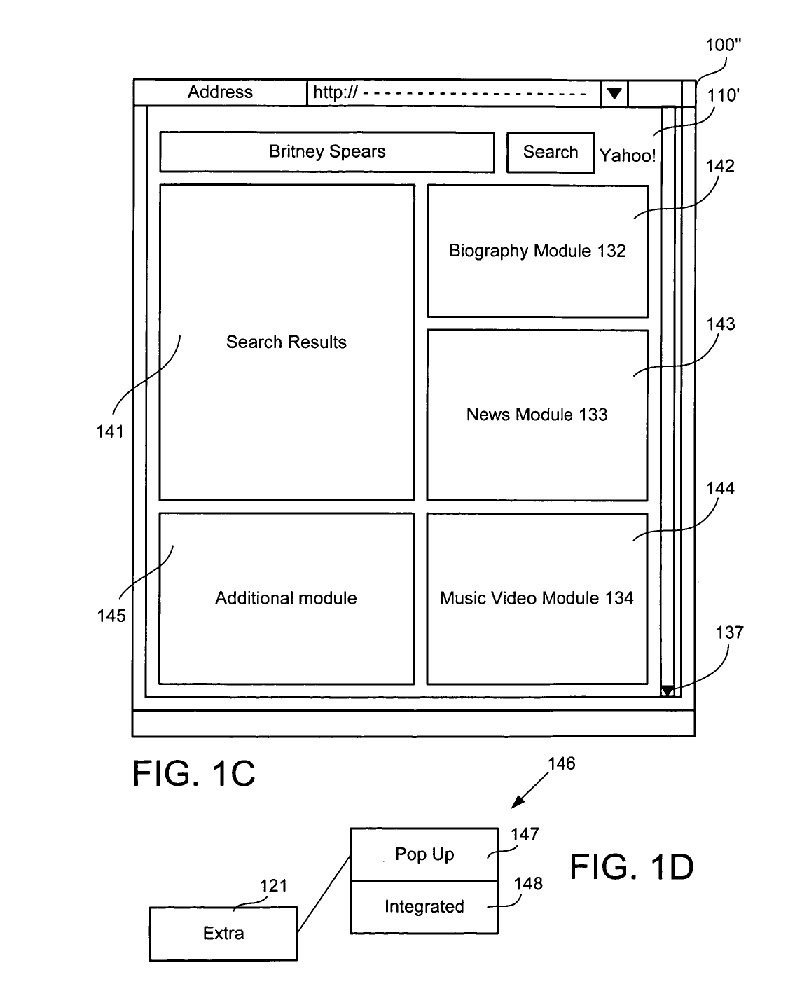

FIG. 1A shows a computer screen 100 with a search result page 110, in accordance with one embodiment of the present invention. When User-1 enters, for example, a search keyword “Britney Spears” (or any other keyword) in a search box, such as a Yahoo! Search™ box, the search result page 110 is presented. In the result page 110, there are a number of areas, such as areas 111, 112, 113, and 114, that show web links and brief descriptions of the web links that are related to “Britney Spears.” Area 118 has additional links and descriptions similar to those in areas 111, 112, 114, and 114. For example, in area 111, there is a “Britney Spears Link-1” 116 on top of an area 117 that shows a brief description of “Britney Spears Link-1.” Users can click on link 116 to access more information about Britney Spears. In addition to a brief description about link 116, area 117 may also include the web address of link 116. If the search for the keyword “Britney Spears” yields results that fit more than one page, at bottom of page 110, there is an area 115 that shows buttons for additional search result pages.

When User-1 views the result page 110, Use-1 can click on one or more of the links in areas 111, 112, 113, 118, and 114 to find the information User-1 is searching for. If the information User-1 is searching for is not on page 110 or User-1 wants more information about “Britney Spears,” User-1 can click on other search result pages using the buttons in area 115. Otherwise, User-1 can launch another search on the current search engine with a different search keyword, such as “Britney Spears concert.” Alternatively, User-1 can launch another search on another search engine or web site. To achieve User-1's goal of searching for information about “Britney Spears”, User-1 may spend substantial time conducting various searches.

Very often Internet users search for information that could also be of interest to other users. Continuing with the example, many Internet users may be interested in information about “Britney Spears.” These Internet users could be interested in her latest album, upcoming concert tour, latest news, and her biography, etc. Since many users are interested in information about Britney Spears, the most popular and most recent information about Britney Spears can be put together and be made into an informational page about Britney Spears. Such an informational page about Britney Spears can be presented to users when they conduct searches for information about Britney Spears. Since the informational page about Britney Spears contains the most popular and most recent information about Britney Spears, its content would satisfy the needs of many people.

At the bottom of screen 100 of FIG. 1A is a tool bar 120. In tool bar 120, there is a button 121 named, for example, “Extra.” When User-1 clicks on the “Extra” button 121, an informational page 130 is presented, as shown in FIG. 1B. A tool bar is a panel on a graphical user interface, as displayed on a screen. On the toolbar, such as the Yahoo! Toolbar™, there could be onscreen buttons, icons, menus, or other input or output elements. The “Extra” button is used to activate a browser extension that enables the retrieving or creation of the informational page 130. A browser extension is a computer program that extends the functionality of a web browser and can be downloaded or accessed. A Toolbar is also a browser extension. However, extension icons/buttons are not required to be part of a Toolbar, and other GUI presentations are possible. In this example, the browser extension associated with the “Extra” button 121 includes a program that enables the retrieving and/or the generation of the informational page 130. Users, such as User-1, can download the browser extension associate with the “Extra” button. Alternatively, the browser extension can be part of a larger browser extension package that includes many features and functions and need to be activated for usage. The term “Extra” is merely used as an example. Other terms can be used. The function of the “Extra” button is mainly to trigger automatic web page augmentation. For example, the informational page 130 is generated automatically (without User-1's involvement) to provide additional information about a topic, keyword, or entry. Once User-1 activates the automatic web page augmentation by pressing (or selecting) the “Extra” button 121, the informational page 130 is automatically displayed for User-1.

In one embodiment, the informational page 130 contains a number of modules of information related to Britney Spears. In FIG. 1B, the information page 130 appears on top of the search result page 110, in accordance with one embodiment of the preset invention. The informational page 130 includes module 131 of related pages, such as pages of Lindsay Lohan, and Paris Hilton, etc. Page 130 also includes module 132 for the biography of Britney Spears. For example, module 130 can include a photo 135 of Britney Spears and an area 136 with biographical description of Britney Spears. In addition, page 130 includes a module 133 for the latest news about Britney Spears. There are several news links, such as “News A1”, “News A2,” etc. Brief descriptions of these news links are shown below each news link. Further, page 130 has a module 134 of Music videos of Britney Spears, which include several popular videos of Britney Spears, such as Video-1, Video-2, and Video-3, etc. Page 130 may include other modules. User-1 can click on arrow 137 to see more modules. Details of how page 130 can be created will be described below.

Alternatively, the information in the informational page 130 can be integrated with the search results. FIG. 1C shows an integrated page 110′ (or a topic page) that shows both the search results and modules of information about Britney Spears, in accordance with one embodiment of the present invention. Integrated page 110′ has an area 141 of search results of Britney Spears, in accordance with one embodiment of the present invention. Again, the topic can be any topic, and Britney Spears is only used as an example. The search result information in area 141 is similar to the search results in page 110 of FIG. 1A. The modules 132, 133, and 134 of FIG. 1B, and other additional modules, such as module 145, can be place in the integrated page 110′. The integrated page 110 allows users to view additional information alongside the search results.

User-1 can choose to have an extra informational page 130 or an integrated page 110′ depending on his/her preference. FIG. 1D shows a selection area 146 that appears when User-1 clicks on the “Extra” button of FIGS. 1A-1C, in accordance with one embodiment of the present invention. Area 146 shows two choices for User-1 to select. One choice is a “pop-up” 147, which will show a separate informational page 130. Another choice is an “integrated” 148, which shows an integrated page 110′ that replaces the original search result page 100. In one embodiment, once the “Extra” button is activated, the functionality of the button stays activated until users deactivate the functionality. For example, the user can click on the button 121 again to deactivate its function. Similarly, if a user chooses the “pop-up” option to select the augmented information to be a separate page, it will stay unless the user makes an alternative selection to choose “integrated.”

An informational page, such as page 130, can also be called a glue page. A glue page can be generated with the one or more identified content modules arranged in a two-dimensional layout. The glue page can be returned as an independent page or can be returned in a topic page (or integrated page) to the user interface on the client, in response to a search query. In one embodiment, a glue page of “Britney Spears” similar to page 130 is returned along with a search result page when User-1 enters the search keyword “britney spears,” if User-1 has previously activated the automatic web page augmentation by pressing the “Extra” button 121. Alternatively, a topic page similar to page 100′, that integrates the search results with the content of the glue page (or informational page), can be returned. The rendered glue page or topic page provides information most relevant to the topic and possible intent of the search query. In another embodiment, pressing the “Extra” button will provide the informational or topic page with automatic web page augmentation (or automatically generated additional information).

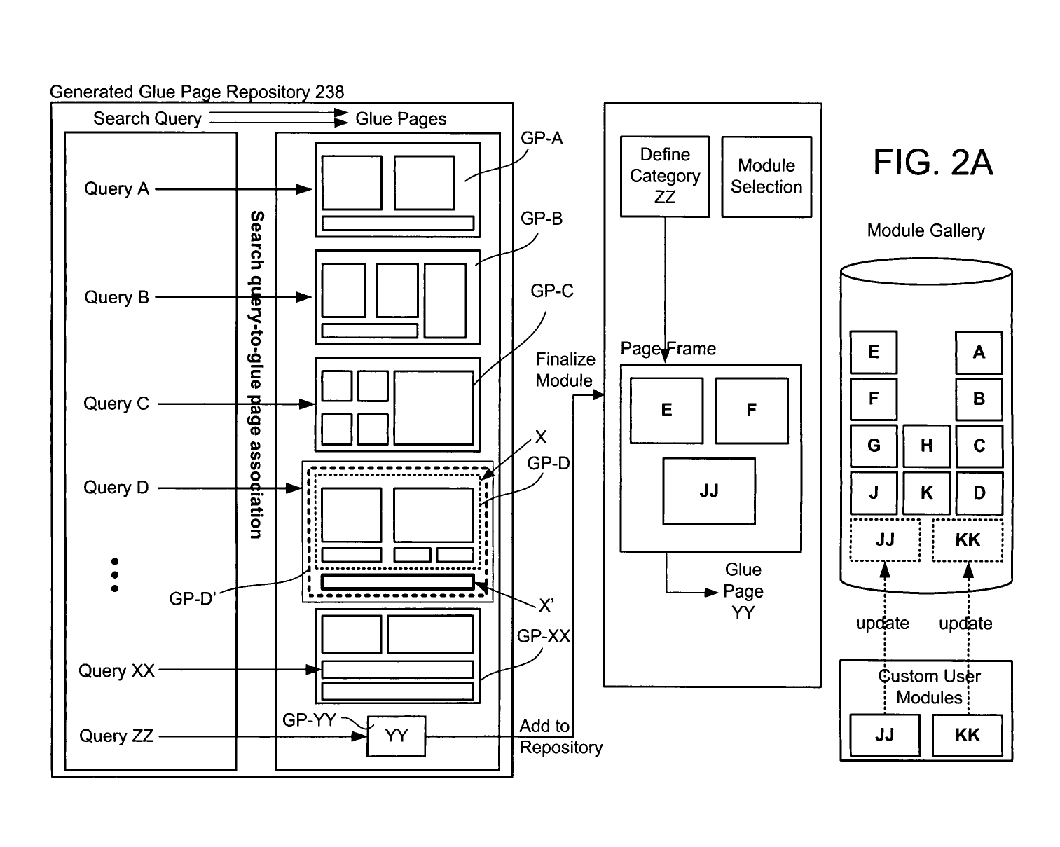

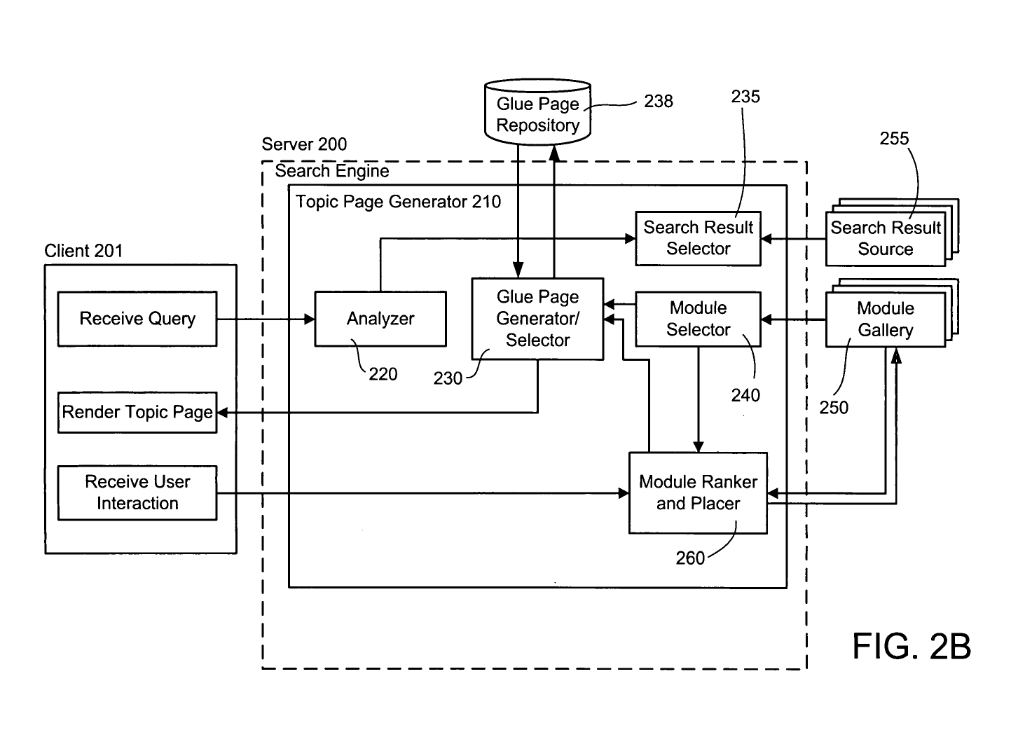

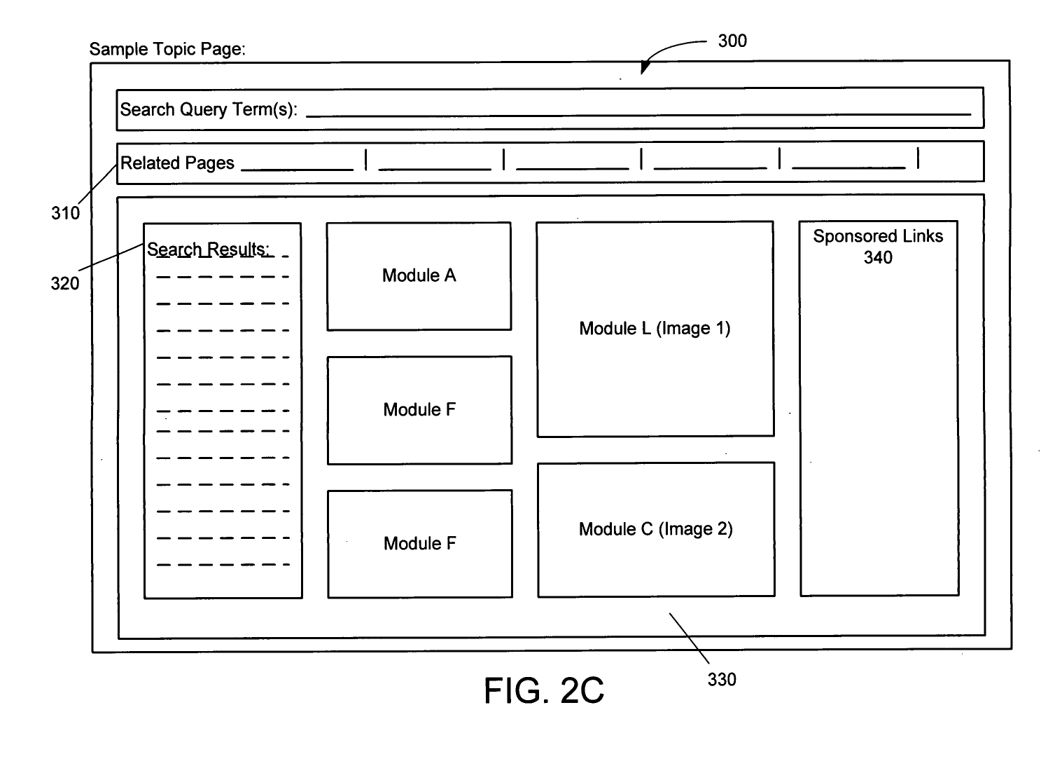

FIG. 2A illustrates a high-level block diagram of various functional elements of a computer system used in generating a glue page for a subject, in one embodiment of the invention. For example, the subject can be any subject. It should be understood that this is only an exemplary system, and should not be considered limiting. Other forms may also be possible, so long as the logic in processing can be carried out to generate the topic pages.

The glue page repository 238 stores a plurality of glue pages for various search queries from varied users. The glue page repository stores the glue pages by mapping search queries to glue pages. For instance, as shown in FIG. 2A a search query, Query A, is mapped to a glue page, GP-A. Search query, Query B, is mapped to glue page GP-B; search query, Query C, to GP-C, and so on. In addition to the standard glue pages, the glue page repository 238 includes one or more customized glue pages. A customized glue page includes edits to the contents of an existing standard glue page. As shown in FIG. 2A, Query D, is associated with a glue page, GP-D with a plurality of modules, X. A new module, X′, is added to GP-D as part of an edit by a user and the customized edited glue page is distinctly stored as GP-D′. The addition of one or more modules is part of customizing the glue page by users to suit the users' needs and interests. In one embodiment, the mapping of a search query to a glue page could be specific for a user to store its personal customizations. Alternatively, a most popular and updated glue page can be mapped to a search query from a user who has never requested or edited a glue page of the subject before. The original glue page, GP-D, may still be used by one or more users for the particular search query. As a result, the search query will return the original glue page, GP-D, for some users, and the customized glue page, GP-D′, for the user that modified the page, and for potentially other users. In addition to adding a module, the customization may also include deleting a module, relocating a module, etc.

In one embodiment, in addition to a plurality of modules that match the search query, the glue page may include custom modules. The custom module may be generated by a user and include content and format provided by the user. The custom module is generated by defining the content. The content may have any one or combination of varied content formats. The custom module is designed based on the content. The defined custom module is then updated in the module gallery available to a search engine on the server so that the custom module may be identified and retrieved during subsequent search queries.

As mentioned in FIG. 1C, the results of the informational page (or glue page) can be integrated with the search results. A web page that shows search results integrated with modules of an informational page (or glue page) can be called a topic page. FIG. 2B illustrates a high-level block diagram of various functional elements of a computer system used in generating a topic page for a search query on a search web page, in one embodiment of the invention. It should be understood that this is only an exemplary system, and should not be considered limiting. Other forms may also be possible, so long as the logic in processing can be carried out to generate the topic pages.

The system of FIG. 2B includes a client 201 with a user interface to receive and transmit a search query. The user interface is communicatively connected to a server 200 through a computer network (not shown), such as an Internet. The connection may be wired or wireless and may use any technology that allows the user interface to interact with the server. The user interface is also used to render a topic page with a glue page that is returned by the server in response to the search query and to capture user interactions at the glue page of a topic page rendered at the client 201.

The server 200 includes a search engine to receive the search query (query) from the client 201. A topic page generator 210 at the search engine processes the query. The topic page generator 210 may be integrated within the search engine or may be distinct from the search engine and may be available to the search engine for processing. The topic page generator 210 includes a plurality of modules, such as an analyzer module 220, a glue page generator/selector module (page selector) 230, a module selector 240, a module ranker and placer 260 and a topic page integrator 270. The analyzer module 220 is configured to receive, analyze and categorize the search query along one or more dimensions. The categories define the purpose of the search query and identify one or more topics, one or more intents and/or a geo location of interest to the user based on the search query. For instance, the purpose of the query may be to shop for better bargains, look for images, look for documentation, etc. It should be noted that the above list of categories should be considered exemplary. Other categories may be identified over time and the search query may be analyzed to identify the additional categories. The page selector module 230 receives the query and categories from the analyzer module 220, searches a glue page repository 238 available to the search engine to identify and select an existing glue page that matches the query. The glue page includes a defined set of modules that were determined during an earlier search using the same search query. The selected glue page is used to generate a topic page.

If an existing glue page is not available in the repository for the query, the page selector 230 is configured to create a glue page. In order to create a glue page, the page selector 230 interacts with a module selector 240, which, in turn, interacts with a module gallery 250 to identify one or more modules that match the query. In one embodiment, the module selector 240 chooses one or more modules by looking at the categories of the query. An algorithm or editorial team associates every combination of categories with a list of modules. The module selector 240 forwards the selected modules to a module ranker and placer (ranker) 260 that ranks and places the selected modules using a glue page template available at the page selector 230. It should be noted that the ranker 260 may be distinct or may be integrated with the module selector 240. The glue page template is a default template that can be used for placing the selected modules. In one embodiment, the glue page template allows the modules to be arranged in a two-dimensional layout. The ranker 260 determines the ranking and placement of the selected modules within the glue page using a ranking algorithm. In one embodiment, the ranking algorithm may be based on how visually interesting the modules are on the glue page. In another embodiment, the ranking algorithm may be based on historical data that shows how often users click on each module. The newly generated glue page with its defined set of modules is returned to the glue page repository 238 for future retrieval and to the user interface on the client 201 as a topic page for rendering, in response to the query.

In one embodiment, one of the modules identified for the glue page is a search results module. The topic page generator 210 may also include a search result selector 235 to identify and select one or more search results that match the query. The search result selector 235 may be integrated within the topic page generator or may be distinct and be available to the topic page generator 210. The search result source 255 may be accessed through a network (not shown). The search result selector 235 integrates the search result into a search results module and forwards the search results module to the module selector 240, which in turn forwards the search results module along with all the other modules to the ranker 260 for ranking and placing the modules in the glue page. The glue page is integrated into a topic page by the page selector 230. The topic page, thus created, includes the most popular and relevant modules for the search query as a whole. The topic page is returned to the user interface at the client 201 for rendering.

Upon rendering of the topic page at the client, one or more edits to one or more modules within the glue page of the topic page is received through user interaction at the client 201. The edits may reflect customization performed on the various modules within the glue page. Generally, the edits may be associated with content modification and layout modification. Some of the edits associated with layout modification may include addition of a module, deletion of a module, relocation of one or more modules, etc. The edits are received by the ranker 260 for dynamically ranking and placing of the modules within the glue page based on the edits. The edits are forwarded to the glue page repository 238 through the page selector 230 for storing so that the glue page with the defined set of modules and associated edits can be retrieved (or recovered) for subsequent rendering at the user interface in response to the search query by the user that made the edits, or, in some embodiments, by other users as well.

The content within the modules in the glue page may include any one or combination of textual information, audio content, video content, graphic images, or any other type of content that can be rendered on the search results webpage. In addition to various factual and informational contents, the modules may include sponsored advertisements from a plurality of sources that are relevant to the search query and the sponsored advertisements may, in turn, include audio, video, graphic or any other form of content that can be rendered on the webpage. Details regarding how to generate an informational page or a topic page can be found in U.S. patent application Ser. No. 12/238,234, which is entitled “Building a Topic Based Webpage Based on Algorithmic And Community Interaction,” and filed on Sep. 25, 2008, and U.S. patent application Ser. No. 12/116,195, which is entitled “Algorithmically Generated Topic Pages,” and filed on May 6, 2008. Both applications are incorporated herein by reference in their entireties for all purposes.

FIG. 2C illustrates a simplified block diagram of another embodiment of a topic page, in accordance with one embodiment of the present invention. The sample topic page 300 includes a glue page with a plurality of modules matching the one or more categories of the search query. The topic page is generated by a page selector that integrates the various modules of the glue page 330. In one embodiment, the modules within the glue page 330 may include a search results module 320 having one or more search results that match the one or more categories of the search query. In addition to the search results module 320, the glue page may also include a plurality of sponsored advertisements (sponsored links) 340. The sponsored links 340 may include a plurality of textual and non-textual content related to the one or more categories of the search query. These sponsored links may be identified and selected during the creation of the glue page. The topic page, in turn, along with the glue page may include a set of related pages 310 that may be associated with the one or more categories of the search query.

Since users can participate in the editing of glue pages, the contents in the glue pages (or informational pages) and topic pages could be very relevant to many users. Providing automatically generated or recovered, or retrieved, web pages of augmented information to Internet users while they conduct searches could improve their search experience. For example, when a user is comparing prices on a particular product, the glue page retrieved could show users' comments about the product and also the most popular site used by online customers to purchase the particular products. Such a glue page could be automatically generated by the system and further improved (or modified) by other users. In addition, such augmented information can be automatically provided to the users without users' effort and involvement in opening web sites, typing in search keywords, and clicking on links, etc.

In addition to conducting searches, users often read content on web pages to gather information. When users read content on web pages, sometimes they encounter terms that they are not familiar with and may need additional information (or contextual help) on those unfamiliar terms. Currently, in order to obtain additional background of such unfamiliar terms, users need to take several process steps, such as accessing a search site, entering search keywords, and clicking on links in the search result pages. It would be desirable to allow users to access to information regarding the unfamiliar terms using a simplified method with fewer process steps. A browser extension is provided to enable simple access of information for terms of augmenation value (or terms of interests to users).

In one embodiment, a browser extension can include a list of terms that can be considered as terms of interest to users (or terms of augmentation value) and term links in a list can be automatically created. The list of terms of augmentation value can include names of people, places, organizations, medical terms, medical terms etc. Overtime, the terms can grow or can be customized for specific users. The browser extension can modify the code of the web page to provide underlines (or highlighting of some type) for terms to enable term link creation. For example, the code of the web page can be HTML (Hypertext Mark-up Language) code, AJAX code, JAVA code, C code, XML code, and any other programming languages, which can provide code or execute code for rendering web pages and augmentation to web pages (including associated highlighting). Users can select the underlined terms to access augmented data or information related to the clicked terms.

The browser extension can enable generating a window to show search results for an underlined term by passing the underlined term to a search engine or accessing database or directory. In one embodiment, the search results can be generated by passing the term to a single search engine. Alternatively, the search results in the window can be generated by combining search results from a number of search engines, databases, lists, or repositories.

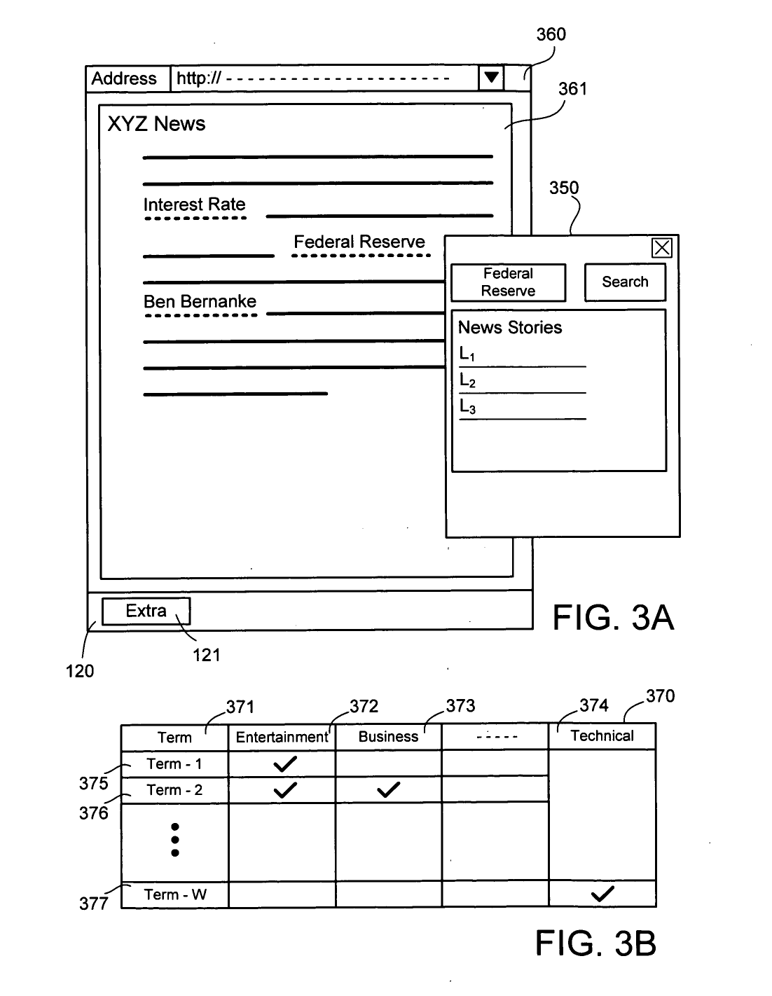

FIG. 3A shows a web page 361 of a news story 362 published by an XYZ news online site, in accordance with one embodiment of the present application. It should be understood that any web page crated by any publisher on the Internet can be processed for augmentation, as described below. Consequently, any web page rendered by a browser is efficiently processed for augmentation, thus providing information related to selected words or terms found on the page.

In this example, the news story is related to predicting the Federal Reserve's decision on interest rates. The web page is displayed in a computer screen 360. After User-O reviews the article, User-O may desire additional information on some of the specific terms in the article. User-O can select the “Extra” button 121 in the tool bar 120 to generate shortcuts for specific terms in the article. After User-O selects the “Extra” button 121, the web page 362 is processed by the browser extension to perform web page augmentation (inserting extra information). After the conversion, selected terms, such as “interest rate”, “Federal Reserve”, and “Ben Bernanke”, are underlined (or in some way highlighted as having more data if selected). If User-O clicks on one of the underlined term, such as “Federal Reserve,” a separate window 350 may be presented. In this embodiment, window 350 shows the search results of the keyword “Federal Reserve.” Window 350 is automatically generated by the browser extension after User-O clicks on the underlined term, “Federal Reserve.”

In one embodiment, the content of the search result page is dependent on the nature (or category) of the keyword. For example, if the term (or keyword) is related to celebrity or politics, search results related to news stories will be shown with a higher priority than other types of information, such as biography or history. When the browser extension sends to term to a central system to obtain search results, the central system can determine the nature of the term to decide the display of the search results. In one embodiment, the central system contains a database with terms of augmentation value and corresponding categories of these terms. The displayed search results depend on the categories the terms of augmentation value. FIG. 3B shows, as an example, a database 370 of terms with augmentation value, in accordance with one embodiment of the present invention. The table includes a number of terms having augmentation value, such as Term-1 in area 375, Term-2 in area 376, . . . , and Term-W in area 377. Each term in database 370 is associated with one or more categories. The examples of categories may include entertainment, business, celebrity, politics, technical, . . . , etc. The associated category(ies) of each term will determine what type of information will be displayed first, as described above. Database 370 can be updated periodically to keep the data up to date.

In another embodiment, the database with terms of augmenation value resides locally on users' computing devices. The browser extension can access such database and can send the identified term along with the category(ies) to a search engine(s). In another embodiment, the terms can be automatically underlined when User-O opens the page, if User-O had activated the “Extra” button (or the function of web page augmentation) at an earlier time.

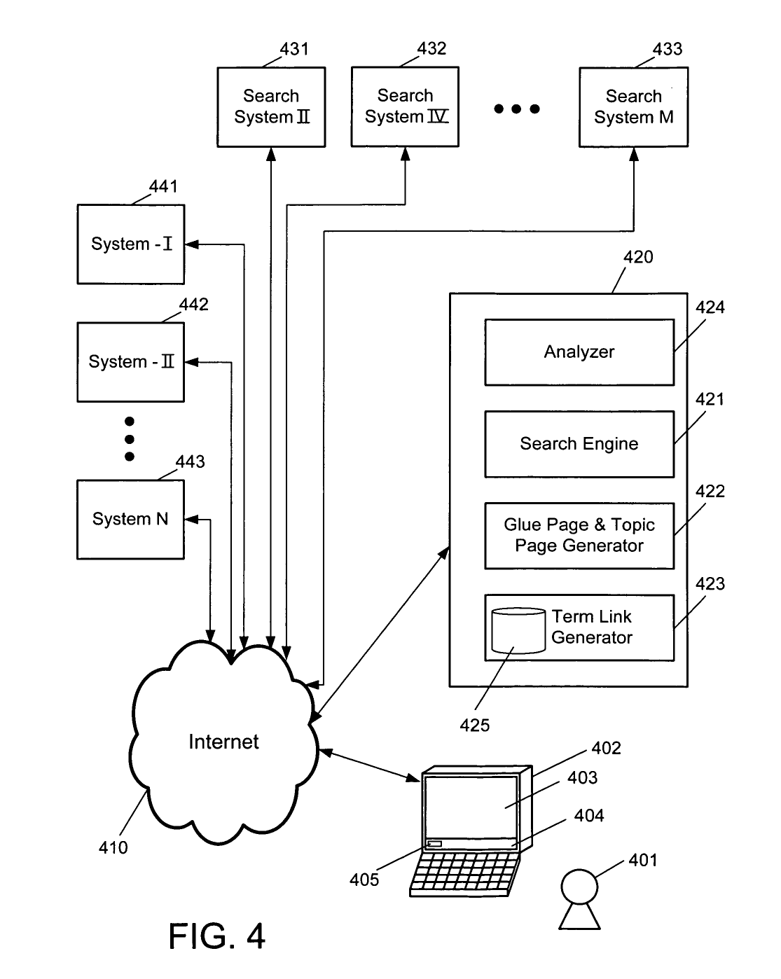

The automatic augmentation of information for web pages (including search result pages) described above enhances and simplifies information gathering for Internet users while they conduct searches or view web pages. FIG. 4 shows a system 400 for automatically generating web page augmentation, in accordance with one embodiment of the present invention. In system 400, a user 401 may interact with a computing system 402. The computing system 402 has a screen 403 for displaying web page(s). The screen 403 also has a tool bar 404, which has a web page augmentation button 405. For example, the web page augmentation button 405 is similar to the “Extra” button 121 described above. The computing system 402 has a browser program (Not shown), which has a browser extension for generating web page augmentation.

In one embodiment, an extension may be code that is integrated with browser code. The extension may also reside as a separate piece of code installed on a computing device or can be partially executed on the computing device and partially executed over the Internet using cloud computing.

The computing system 402 is connected to the Internet 410, either through wire or wireless, to access a system 420 of a search site. System 420 has a search engine 421, which indexes content in numerous systems, including System-I 441, System-II 442, . . . , and System-N 443, connected to the Internet 410 to enable users of the Internet 410 to conduct searches. System 420 also has a Glue Page and Topic Page generator 422. Details of the Glue Page and Topic Page generator have been described above. Further, system 420 has a term link generator 423. The features and functionalities of a term link has been discussed above. In one embodiment, the term link generator 423 includes a database of terms of augmentation value. An example of the database is described above in FIG. 3B.

In one embodiment, user 401 requests web page augmentation by pushing the web page augmentation button 405 before, during or after conducting a search. When the request for augmentation is selected, the browser extension at computing system 402 retrieves and sends the search keyword(s) entered by user 401 to conduct the search to system 420. Depending on the what user 401 has specified, system 420 can return a glue page or a topic page recovered or generated by the Glue Page and Topic Page generator 422. The retrieving and generation of glue page or topic page have been described above. As mentioned above, search results from other search site(s) or system(s), such as Search-System-II 431, Search-System-III 432, and other search systems, can be included in the glue page or topic page returned to user 401. In another embodiment, user 401 activates the web page augmentation feature by selecting the web page augmentation button 405. Once the feature is activated, each time a search result page is returned after user 401 issues a search query, the result page can be returned in the form of a topic page or with a glue page. The topic page or the glue page include modules with information related to the search keyword.

In another embodiment, user 401 requests web page augmentation by selecting the web page augmentation button 405 while viewing a web page. The browser extension processes and sends the code of the web page to the term link generator 423 of system 420. The term link generator 423 returns a revised code for the web page, which includes the code for underlying (or highlighting) specific terms for term links, to the web browser of computing system 402. The new code of the web page is displayed on the computer screen 403 in place of the original code. The newly displayed web page looks the same as the original web page with the exception that some specific terms are underlined. Alternatively, the underlying of the specific terms is performed by the browser extension. The term link generator 423 may also be part of the browser extension of the computing system 402. When user 401 views the new (or revised) web page, user 401 can point the input device to a specific term and can select the term. When the term is selected, the term link generator 423 works with search engine 421 to retrieve search results related to the term and return the search results in a separate window in a manner as described above in FIG. 3A. The request for web page augmentation can occur when the user selects the web page augmentation button or can automatically occur if the user has activated the feature earlier.

In one embodiment, system 420 includes an analyzer 424. The analyzer 424 determines the nature of incoming requests and determine where to sent the request. For example, if an incoming request is only for search, the analyzer 424 can send the request to search engine 421, after the analysis is completed. If the incoming request is for search result augmentation, the analyzer 424 can send the request to the glue page and topic page generator 422. In addition, if the incoming request is for generating term links for a web page, the analyzer 424 can send the request to the term link generator 423.

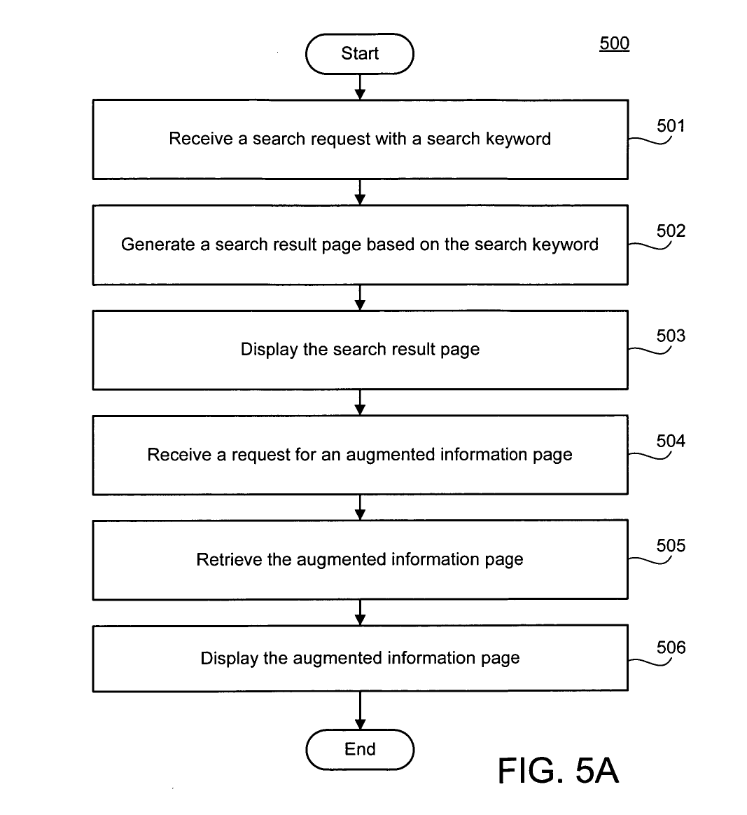

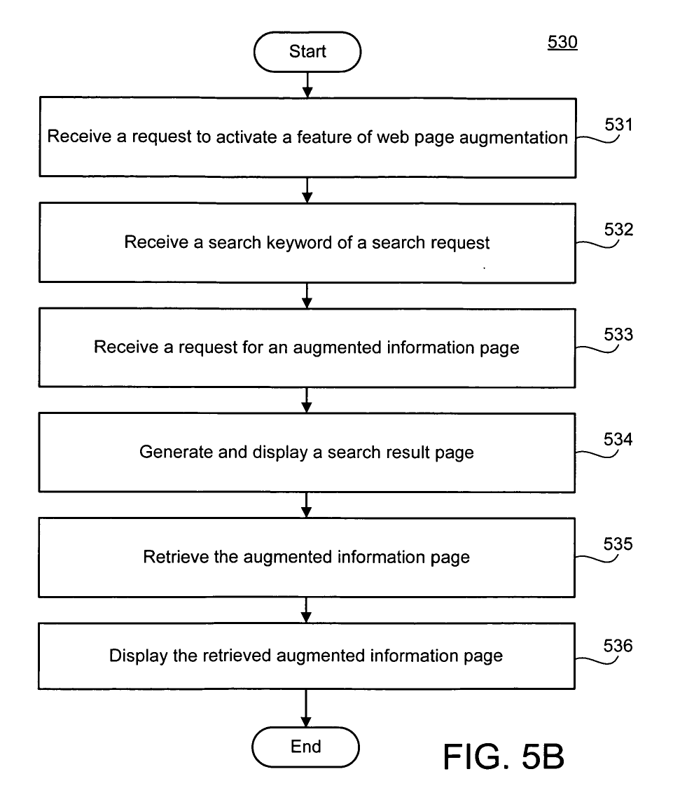

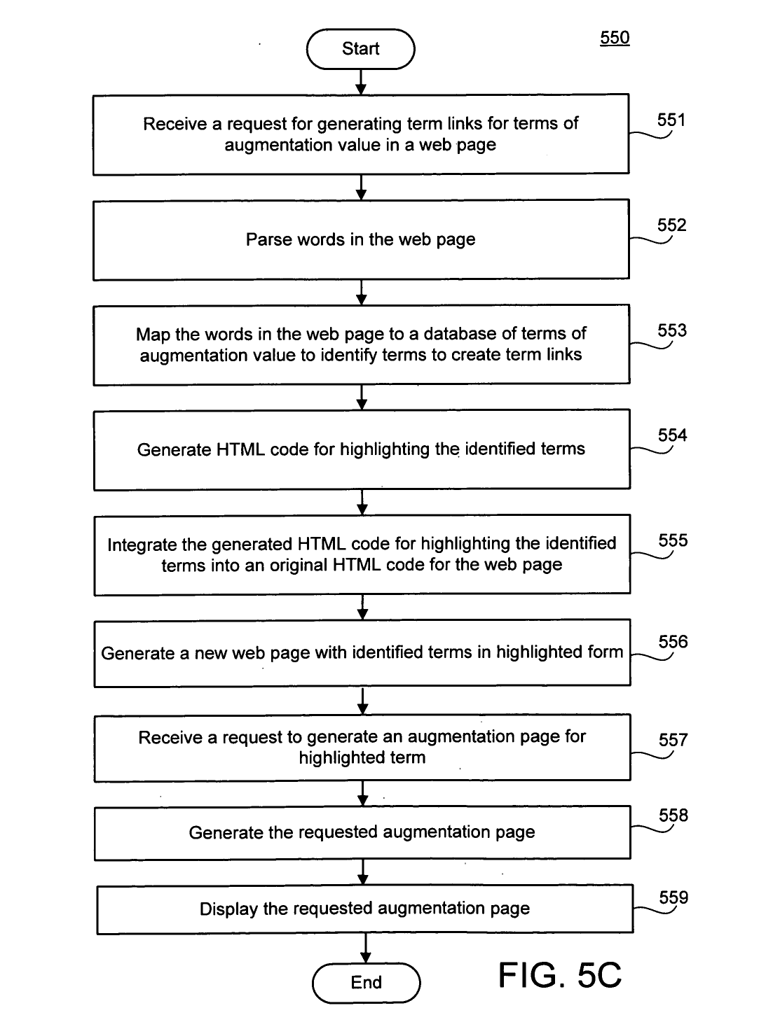

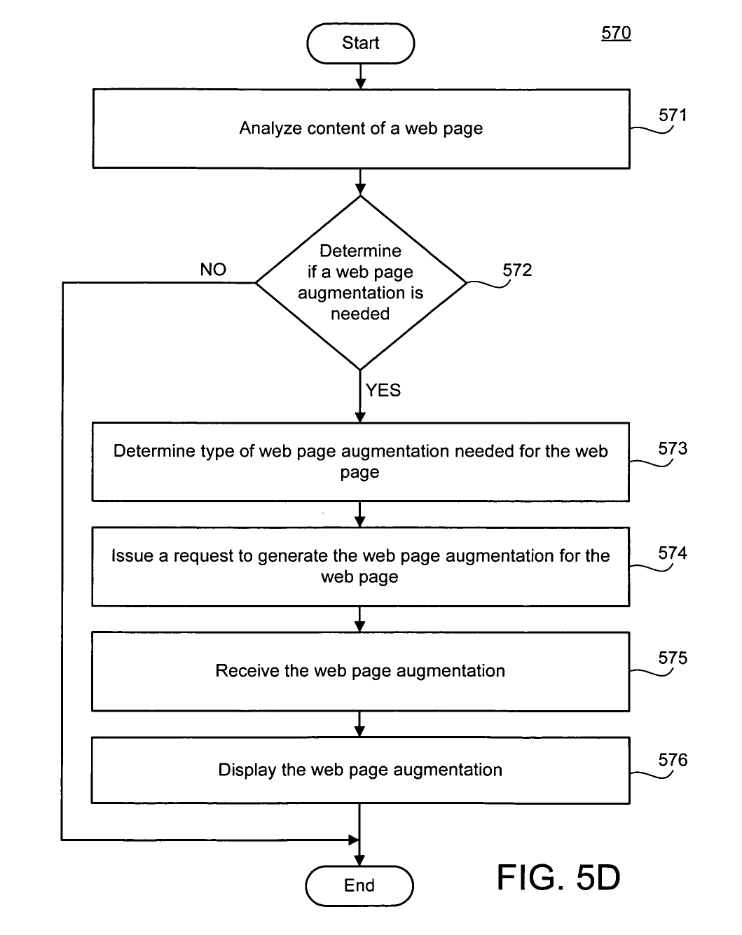

FIG. 5A shows a process flow 500 for automatically generating a web page augmentation, in accordance with one embodiment of the present invention. At operation 501, a search request with a search keyword is received. At operation 502, a search result page is generated, based on the search keyword. At operation 503, the generated search result is shown on a display screen implemented by a user. After viewing the search results, the user could decide whether he/she needs additional information (or augmented information) for the search keyword. At operation 504, a request for generating an augmented information page is received. As mentioned above, the user can select to trigger the generation of the glue page. The selection of the button triggers the activation of the browser extension. Alternatively, the user can activate the request by downloading a browser extension with a program for processing the request, and/or by selecting a button to activate the browser extension. In this case, entering of the search keyword or the display of the search result page can trigger the browser extension to request for the augmented information page. button to activate the browser extension. In this case, entering of the search keyword or the display of the search result page can trigger the browser extension to request for the augmented information page.

The browser extension retrieves the search keyword that had been entered previously and forwards the search keyword to the augmented information page generator. The browser extension also identifies the origin (from which computer) and destination (to which system the request is sent) of the request. A request along with the search keyword is sent to an augmented information page generator, such as the glue page and topic page generator mentioned above. At operation 505, an augmented information page related to the search keyword is retrieved, either by recovering or by generating (on the fly) the page. If the augmented information page is pre-constructed, it is recovered. Otherwise, the system can generate the page on the fly, based on the search keyword. The augmented information page is returned to the screen of the user's computer and is displayed on the screen at operation 506. The augmented information page can be a glue page or a topic page.

FIG. 5B shows a process flow 530 for automatically generating a web page augmentation, in accordance with another embodiment of the present invention. At operation 531, a feature of generating an augmented information page for a web page is activated. For example, the user can push a button or download a program to activate the feature. At operation 532, a request for search results of a search keyword is received. Since the feature of web page augmentation is activated, the browser extension receives the search keyword entered by the user. The browser extension sends the search keyword to the augmented information page generator. At operation 533, a request for an augmented information page is received. At operation 534, a search result page is generated and returned to the user's computer, and the search result page is displayed on the user's computer. At operation 535, an augmented information page is retrieved (recovered or generated), and is returned to the user's computer. The augmented information page is displayed on the user's computer at operation 536. The augmented information page can appear on top of the search result page (a glue page), or in place of the search result page (a topic page).

FIG. 5C shows another process flow 550 of generating a web page augmentation, in accordance with yet another embodiment of the present invention. At operation 551, a request for generating term links for terms of augmentation value in a web page is received (by a term link generator). For example, a user clicks on a link or enters a URL to access web page. At operation 552, a request for generating term links is received. As mentioned above, the user could decide that he/she needs augmented data for terms on the web page and makes such a request. In one embodiment, the request triggered automatically. The user could have activated the web page augmentation function earlier and the function would stay active until the user deactivates the function. At operation 553, the words in the web page are parsed. At operation 554, words in the web page are mapped to a database of terms of augmentation value to identify terms in the web page that are of augmentation value. At operation 554, the code for highlighting the identified terms is generated. Highlighting can be, for example, underlining, bolding, color text, color change, etc. At operation 554, the generated code for highlight the identified terms is integrated into the code of the web page. At operation 555, a new web page with identified terms in highlighted form is generated. The identified terms in highlighted form signals these terms can generate an augmentation page (or window). At operation 556, a request to generate an augmentation page of a highlighted term is received. At operation 557, the augmentation page for the highlighted term is generated. In one embodiment, the augmentation page includes search results related to the highlighted term. In one embodiment, the nature of (or a category or categories associated with) the highlighted term affects the display of the search results. At operation 558, the generated augmentation page is displayed on a screen.

In another embodiment, when a new web page is visited in a browser, browser extension first determines what type of activity the web page is associated with. For example, the activity of the web page could be related to search, news, communication (a social networking site), or shopping. Based on the type of activity and the page content, the browser extension program determines whether augmentation is needed, and how to augment the page. The web page augmentation is provided automatically without users' involvement.

FIG. 5D shows a process flow 570 for automatically generating a web page augmentation, in accordance with one embodiment of the present invention. At operation 571, the content of a web page is analyzed by the browser extension. At operation 572, the browser extension determines if a web page augmentation is needed, based on the content of the web page. If a web page augmentation is needed, the browser extension determines the types of the web page augmentation that is needed for the web page. For example, the browser extension can determine if the web page is a search result page or a news web page to decide whether an augmented information page is needed or generating shortcuts is needed. At operation 574, the browser extension issues a request to generate the web page augmentation for the web page. The web page augmentation can be an augmented information page, such as a glue page or a topic page, or a revised web page with shortcuts. At operation 575, the web page augmentation for the web page is received by the computing system of the user. At operation 576, the web page augmentation for the web page is displayed on the computing system.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A computer implemented method for automatically providing a web page augmentation, comprising:
receiving a search request with a search keyword;
generating a search result page having search results, wherein the search results are generated based on the search keyword;
displaying the search result page;
receiving a request for an augmented information page for the search result page, wherein the request includes the search keyword;
retrieving the augmented information page; and
displaying the augmented information page that is retrieved.

2. The computer implemented method of claim 1, wherein the retrieving of the requested augmented information page includes determining if the requested augmented information page for the search result page is pre-constructed,
if the requested augmented information page is pre-constructed, recovering the requested augmented information page from a system with the requested augmented information page, and
if the requested information page is not pre-constructed, the requested information page is generated on the fly.

3. The computer implemented method of claim 1, wherein the augmented information page contains search results for the search keyword and the augmented information page is displayed in place of the search result page.

4. The computer implemented method of claim 1, wherein the request for the augmented information page is issued by a browser extension and the browser extension retrieves the search keyword.

5. The computer implemented method of claim 1, wherein the augmented information page includes modules with different types of information related to the search keyword.

6. The computer implemented method of claim 5, wherein the different types of information in the modules include news, audios, videos, images, biographies, blogs, and links to web sites.

7. The computer implemented method of claim 1, wherein the request for the augmented information page is initiated by detecting user selection after the search result page has been displayed.

8. The computer implemented method of claim 1, wherein the request for the augmented information page is issued by a browser extension automatically, and wherein a feature of requesting augmented information pages by using the browser extension has been activated.

9. The computer implemented method of claim 1, wherein a web site that receives the search request and generates the search result page is different from a web site that receives the request for the augmented information page and retrieves the augmented information page.

10. The computer implemented method of claim 1, wherein the purpose of the search request may include shopping for better bargains, looking for images, looking for documentations, looking for videos, looking for audios, and looking for information.

11. A computer implemented method for automatically providing a web page augmentation, comprising:
receiving a request to generate term links for terms of augmentation value in a web page;
parsing words in the web page;
mapping the words in the web page to a database of terms of augmentation value to identify terms to create the term links;
generating code for highlighting the identified terms;
integrating the generated code into an original code of the web page;
generating a new web page with the identified terms highlighted;
receiving a request to generate an augmentation page for a highlighted term in the new web page;
generating the requested augmentation page; and
displaying the requested augmentation page.

12. The computer implemented method of claim 11, wherein the request for generating term links is issued by a browser extension and the original code of the web page is sent with the request.

13. The computer implemented method of claim 11, wherein the request for generating term links is initiated by detecting selection of the highlighted term.

14. The computer implemented method of claim 11, wherein the request for generating term links is issued by a browser extension automatically, and wherein a feature of generating term links on web pages by using the browser extension has been activated.

15. A computer implemented method for automatically providing a web page augmentation, comprising:
analyzing content of a web page; and
determining if a web page augmentation is needed for the web page, if the web page augmentation is needed,
determining type of web page augmentation needed for the web page based on the content of the web page,
issuing a request to generate the web page augmentation, receiving the web page augmentation sent by a web page augmentation generating system, and
displaying the web page augmentation,
if the web page augmentation is not needed, do nothing.

16. The computer implemented method of claim 15, wherein a browser extension enables issuing the request to generate the web page augmentation.

17. A system for automatically generating a web page augmentation, comprising:
a central system having,
a search engine for generating search results for search queries;
a glue page and topic page generator, wherein a glue page is an augmented information page of a search query and a topic page is an augmented web page with search results for the search query and augmented information related to the search query; and
a shortcut generator, wherein the shortcut generator creates shortcuts for web pages; and
a computer with a browser extension, wherein the browser extension is controllable for user activation, and wherein the browser extension issues requests for web page augmentation to the central system.

18. The system of claim 17, wherein an augmented information page for a search keyword is recovered or generated by the glue and topic page generator, and wherein the augmented information page is provided to the computer when the browser extension sends a request for the augmented information page with the search keyword.

19. The system of claim 17, wherein information terms of a web page by the shortcut generator is underlined when the browser extension sends a request to create shortcuts for the web page, and wherein the request is sent with an original code of the web page.

20. The system of claim 17, wherein the central system includes an analyzer, and wherein the analyzer determines if an incoming request is for searching, for web page augmentation of search query, or for generating shortcuts for a web page.
